(19) United States
(12) Patent Application Publication
(10) Pub. No.: US 2005/0038253 A1
(43) Pub. Date: Feb. 17, 2005

(54) Method for production of alkali metal dialkylamides

(76) Inventors: Ulrich Steinbrenner, Neustadt (DE); Ralf Bohling, Griesheim (DE); Frank Funke, Mannheim (DE); Wolfgang Harder, Weinheim (DE)

Correspondence Address: KEIL & WEINKAUF, 1350 CONNECTICUT AVENUE, N.W., WASHINGTON, DC, 20036, US

(21) Appl. No.: 10/495,356

(22) PCT Filed: Nov. 8, 2002
(86) PCT No.: PCT/EP02/12528

(30) Foreign Application Priority Data
Nov. 12, 2001 (DE) 10155474.5

(51) Int. Cl. C07F 1/04; C07F 1/02; C07F 1/06

(52) U.S. Cl. 546/184; 564/463; 260/665 R

(57) ABSTRACT

A process for preparing dialkylamides of the alkali metals by reacting the corresponding dialkylamine with the corresponding alkali metal in the presence of an electron-donating substance selected from the group consisting of 1,3-butadiene, isoprene, naphthalene and styrene with formation of small amounts of butenyldialkylamine comprises suspending the corresponding alkali metal in a solvent and subsequently adding dialkylamine and electron-donating substance in such a way that the dialkylamine is present in an amount of up to 45% by weight, preferably up to 25% by, weight, in particular up to 15% by weight, and the butadiene is present in an amount of up to 5% by weight, preferably up to 3% by weight, in particular up to 1.5% by weight.

The present invention relates to a process for preparing alkali metal dialkylamides from a primary or secondary alkylamine and alkali metal with addition of 1,3-butadiene as electron transferrer. As a result of a particular concentration of 1,3-butadiene based on the amine being maintained during addition of the 1,3-butadiene, only a small amount of butadiene addition products is formed. The amides prepared by the process of the present invention are particularly suitable as catalysts in the preparation of trialkylamines by addition of olefins onto dialkylamine, in particular the preparation of triethylamine from ethylene and diethylamine.

A number of methods of preparing alkali metal dialkylamides are known from the prior art. In many cases, a compound of the alkali metal is used as starting material and is reacted with an olefin in an addition reaction. Known reactions are, for instance, the reaction of organometallic compounds of alkali metals, for example an alkali metal alkyl with dialkylamine, and the reaction of alkali metal hydride with dimethylamine.

The direct reaction of an alkali metal with an amine without addition of further substances which accelerate or catalyze the reaction is possible only in particular cases, for example when using reactive amines. Aromatic amines such as aniline generally react readily with customary alkali metals. In the case of aliphatic amines, the reaction is generally only successful when using monomethylamine. Another group of starting materials which is suitable for preparing such amides by reaction with an alkali metal are hexaalkyldisilazanes, for example hexamethyldisilazane.

The direct reaction of dialkylamines with alkali metal is, however, successful when electron-donating substances are added. Suitable substances of this type are, in particular, conjugated dienes, preferably 1,3-butadiene, isoprene, naphthalene and styrene. This method of carrying out the reaction makes it possible to synthesize dialkylamides in good yields. Examples of such preparative processes for amides are described in U.S. Pat. No. 2,799,705, U.S. Pat. No. 2,750,417, U.S. Pat. No. 4,595,779 and WO 93/14061. However, a critical aspect is the choice of the electron-donating substances.

Naphthalene and styrene give good results, but are either available only in small amounts (naphthalene) or are a valuable starting material for chemical products (styrene). Cyclohexadiene and isoprene are compounds which are obtainable in only minor amounts from petrochemical synthesis and are therefore difficult to procure or are too expensive for use in an industrial process.

In contrast, 1,3-butadiene is a product which is available in large amounts and at low cost. However, a factor which frequently counts against the use of 1,3-butadiene as electron-donating substance in the synthesis of alkali metal amides from olefins and dialkylamines is the fact that 1,3-butadiene adds onto dialkylamine snore readily than do the other electron-donating substances. This forms the corresponding butenyldialkylamine. This can frequently be removed from the amide formed only with disproportionate difficulty, if at all, and is present in the end product as in undesirable impurity when the amide is used as catalyst in the synthesis of trialkylamine Particularly in the synthesis of triethylamine from diethylamine and ethylene, the by-product butenyldiethylamine can be separated from the triethylamine product only with considerable difficulty.

It is an object of the present invention to provide a process for preparing alkali metal dialkylamides from dialkylamine and alkali metal in which 1,3-butadiene can be used as electron-donating substance. The amide obtained should have a low level of contamination by the addition product butenyldiethylamine and be able to be used as catalyst in the synthesis of trialkylamines, in particular triethylamine, from the corresponding dialkylamine and olefin.

This object is achieved by a process for preparing dialkylamides of the alkali metals by reacting the corresponding dialkylamine with the corresponding alkali metal in the presence of 1,3-butadiene with formation of small amounts of butenyldialkylamine, which comprises suspending the alkali metal it a solvent and subsequently adding dialkylamine and 1,3-butadiene in such a way that ≦45% by weight of dialkylamine and <5% by weight of 1,3-butadiene are present in the solution.

The concentration of dialkylamine is preferably up to 25% by weight, in particular up to 15% by weight. As regards 1,3-butadiene, it is preferred that its concentration in the reaction mixture is up to 3% by weight, in particular up to 1.5% by weight.

It has been found that only a small amount of butenyldialkylamine is formed when the reaction is carried out by adding dialkylamine and 1,3-butadiene in such a way that the abovementioned concentrations of the two starting materials are present in the reaction solution.

In the process of the present invention, the addition of the two starting materials is carried out in such a way that an increase in the concentration of these starting materials above the limits indicated is prevented. The reaction conditions can be selected so that the steady-state concentration of one or both starting materials is virtually 0%, i.e. the starting material reacts immediately on addition and the steady-state concentration is below the detection limits which can be achieved by means of customary instruments.

Use is generally made of technical-grade alkali metal which is contaminated by up to 10% by weight of oxides, hydroxides, calcium and the other alkali metals. Other elements can be present in traces (<1% by weight), but these generally do not interfere even in higher concentrations. It is naturally also possible to use prepurified alkali metal in which the impurities mentioned are not present or present only in traces. For cost reasons, technical-grade alkali metal is generally preferred. It is possible to use all alkali metals; preference is given to using Li, Na or K, more preferably Na or K, in particular Na. Mixtures of the alkali metals can also be used if desired.

Prior to introduction into the reaction vessel, the alkali metal is dispersed in a suitable inert solvent. As inert solvents, preference is given to using satiated hydrocarbons, preferably low-boiling paraffins such as n-butane, i-butane, pentanes and hexanes, cyclohexane and mixtures thereof or high-boiling paraffins comprising branched or unbranched, saturated cycloparaffins, for example white oil. Other suitable inert solvents are monoolefins, preferably n-butenes, isobutene, pentenes and hexenes. Trialkylamines are also suitable solvents. Since the amide prepared according to the present invention or the solution of this amide obtained in the process of the present invention is, in a preferred use which is likewise subject matter of the present invention, used as catalyst in the preparation of trialkylamine, a trialkylamine used as solvent is preferably the trialkylamine which is obtained in the subsequent trialkylamine synthesis.

The solvents mentioned are Generally technical-trade materials and can also contain acidic impurities such as water, aldehydes, ketones, amides, nitriles or alcohols in small amounts.

The dispersion step can be carried out above the melting point of the alkali metal using, for example, a suitable stirrer, a nozzle, a reaction mixing pump or a pump and a static mixer. The alkali metal can also be injected into cold solvent or sprayed onto cold solvent from the gas phase. Spraying into cold gas with subsequent redispersion is also possible.

Further possibilities are to disperse the alkali metal in a mixture of inert solvent and starting amine or to disperse the alkali metal in the solvent or solvents and add the appropriate starting amine. A separate apparatus may, if desired, be used for the dispersion procedure, for example a stirred vessel, a nozzle or a reaction mixing pump.

In the preparation of the amide, the alkali metal is generally introduced into the reactor in the form of fine particles. In the case of sodium, these particles preferably have a size distribution such that 50% by weight of the particles have a size of <1000 μm, more preferably <300 μm, in particular <100 μm.

In one embodiment of the present invention, the alkali metal is dispersed in a paraffin and at least the major part of this paraffin is decanted off and replaced by trialkylamine and/or dialkylamine before the alkali metal is used in the reaction

1,3-Butadiene is subsequently added either alone or in admixture with the starting dialkylamine. Alternatively, simultaneous addition of the 1,3-butadiene and the dialkylamine is also possible.

The dialkylamine employed and 1,3-butadiene can be used as technical-grade products or in purified form. Dialkylamines can, for example, be contaminated by small amounts of water, monoalkylamine, alcohols, nitriles, amides, N-alkylidenealkylimines and other dialkylamines and trialkylamines. 1,3-Butadiene may be contaminated by water, other C₄-hydrocarbons, in particular dimerization and oligomerization products of 1,3-butadiene, for example, 1,2-divinylcyclobutadiene, 4-vinylcyclohex-1-ene and 1,5-cyclooctadiene, and is usually stabilized by means of small amounts of free-radical traps, In place of 1,3-butadiene, it is also possible to use 1,3-butadiene-containing hydrocarbon mixtures, for example C4 fractions as are obtained in the cracking of naphtha, in the dehydrogenation of LPG or LNG or in the Fischer-Tropsch synthesis. Acidic impurities such as water, alcohols or C—H-acid compounds, for example nitriles, amides or alkynes, do not interfere. A decrease in yield may sometimes be observed.

Preference is given to adding about 5-10,% of the 1,3-butadiene or of the 1,3-butadiene/dialkylamine mixture at the beginning and waiting for the reaction to start. In the preparation of the amide catalyst from elemental metal, preferably sodium, a temperature of from −30 to 90° C., preferably from 0 to 70° C., in particular from 30 to 50° C., is maintained.

As regards the concentrations of dialkylamine and butadiene in the reaction mixture which are employed according to the present invention, it is not necessary for the concentration to be at a steady-state value during; the entire reaction. Fluctuations within the abovementioned values, i.e. including tire preferred and particularly preferred values, have virtually no effects on the course of the reaction.

A further parameter in the process of the present invention for preparing alkali metal amides which can have an influence on the product distribution is the molar ratio of 1,3-butadiene to the alkali metal used. This is preferably from 0.5 to 1.2, more preferably from 0.5 to 1.0, in particular from 0.5 to 0.7.

The entire synthesis can be carried out batchwise or continuously in a stirred vessel or continuously in a flow tube, a loop reactor or a cascade of stirred vessels. In the continuous synthesis, the alkali metal is, for example, injected continuously into a stream of trialkylamine, this stream is cooled aid 1,3-butadiene and dialkylamine are added via intermediate introduction points.

After the reaction of the alkali metal with the dialkylamine under the above-described conditions, a suspension of the alkali metal dialkylamide in the solvent or solvent mixture used is obtained. Apart from the amide and the solvent or solvents, the mixture further comprises varying amounts of dialkylamine, butenyldialkylamine (from the addition reaction with the 1,3-butadiene) and butenes. This mixture can be freed of the undesirable impurities and then be used as catalyst in the hydroamination reaction. However, it is more advantageous to use this mixture as such in the hydroamination reaction. As a result of the minimal formation of butenyldialkylamines, generally N-but-3-enedialkylamine, N-but-(trans,cis)-2-enedialkylamine and N-but-(trans,cis)-1-enedialkylamine in various ratios, the trialkylamine prepared in the hydroamination also contains only small amounts of the butenyl-substituted amines.

A mixture of alkali metal dialkylamide, any solvent used and secondary amine/amines is obtained. This mixture obtained directly after the reaction has a molar ratio of all hydroamination products obtained to the alkali metal dialkylamide, calculated as monomer MNR₂, where M=alkali metal, of <1.5, preferably <1, in particular <0.3.

The process of the present invention for preparing an amide or the subsequent hydroamination is generally suitable for the use of amines (as starting material for the preparation of diamide and trialkylamine) having C₁-C₅₀-alkyl groups. The alkyl groups can be linear or branched and acyclic or cyclic and may, if desired, bear one or more inert substituents. It is likewise possible to use amines having substituents which bear aromatic or olefinic substituents as long as these substituents are lot conjugated with the nitrogen. Examples of such substituents are benzyl, phenethyl, hex-4-enyl and allyl. The process of the present invention is particularly advantageous in the case of amines which have relatively nonbulky substituents, since the tendency of the 1,3-butadiene to undergo an addition reaction with the amide increases as the space taken up by the substituents on the nitrogen decreases. The alkyl groups are preferably selected from among methyl, ethyl, n-propyl, i-propyl, n-butyl, sec-butyl, i-butyl, tert-butyl, n pentyl i-pentyl, decyl, dodecyl, hexadecyl, cyclohexyl, cyclopentyl; among these alkyl substituents, preference is given to those which result in alkylamines having a hydrogen atom in the β position relative to the nitrogen atom. The alkyl groups are particularly preferably selected from among ethyl and n-butyl. In the most preferred embodiment of the present invention, the starting amine is diethylamine.

The process of the present invention is also suitable for preparing the alkali metal amides of monoalkylamines. Compared to dialkylamines, these frequently have different reactivities in the reaction with alkali metals. This is largely attributable to the different steric demands of the monoalkylamines compared to the dialkylamine having the same alkyl groups as in the corresponding monosubstituted amine. Monomethylamine occupies a special position since it reacts with alkali metals to form amides even without addition of an electron-donating substance.

The hydroamination using the amides prepared according to the present invention as catalyst is carried out under the customary pressure and temperature conditions known to those skilled in the art. The temperatures are generally in the range from 30 to 180° C., preferably from 50 to 100° C., and pressures are from 1 to 200 bar.

The olefins with which the starting amine is reacted are generally olefins having from 2 to 20 carbon atoms. Preferred olefins are ethylene, propylene, 1-butene, 2-butene or cyclohexene; particular preference is given to the olefin ethylene.

The process of the present invention allows the preparation of an alkali metal dialkylamide from alkali metal and the corresponding; dialkylamine to be carried out using inexpensive and readily available 1,3-butadiene without an unacceptably large amount of butadiene addition product being formed. The process of the present invention can also be carried out using other known electron-donating substances, for example isoprene, cyclohexadiene, naphthalene or styrene. Since the substances mentioned have less tendency to undergo an addition reaction with amines than does 1,3-butadiene, the advantages obtained when using the process of the present invention over the previously known processes are generally less when using other electron-donating substances.

The invention is illustrated by the following examples.

### EXAMPLES

General

All solvents used were dried overnight using 3A molecular sieves. All work was carried out under arson as protective gas.

Technical-grade sodium was dispersed in n-dodecane by means of an Ultraturrax® at 150° C., and the dispersion was then cooled without stirring (50% by weight <280 μm droplet diameter). The Na was subsequently centrifuged off, slurried in the mixed solvent [diethylamine or triethylamine (“DEA” or “TEA”) or n-heptane] and centrifuged off again. This process was repeated until <1% by weight of dodecane was present in the solvent.

The sodium was subsequently slurried in the indicated amount of the respective solvent, a defined amount of n-undecane was added as internal standard and the mixture was transferred to a stirred tank reactor having a capacity of 800 ml, blanketed with 3 bar of argon, thermostatted to the desired temperature and diethylamine and 1,3-butadiene were metered in in liquid form as described below.

During the reaction, samples of about 3 ml were taken via a filter having a pore width of 7 μm, admixed with one drop of 50% aqueous KOH and the organic phase was analyzed by means of GC.

After the reaction was complete, the NaNEt₂ yield was determined.

The course of the reaction can be followed via the formation of butenes (1- and 2-butene). The following reaction equation applies approximately:
2Na+2HNEt₂+C₄H₆ [symbol] 2NaNEt₂+2C₄H_{S}

Conversion and selectivity can thus be estimated from thee content of butenes.

In the following tables, the percentages by weight reported under “Analysis” are rounded values obtained from the amount in [g] found by GC analysis.

### Comparative Example 1

A dispersion of 0.5 mol of Na in 302 g of DEA and 12.165 g of n-undecane was initially placed in the reactor. A mixture of 0.55 mol of 1,3-butadiene and 0.55 mol of DEA was then metered in at 30° C. (about 5% over 6 min, 29 min delay, then remaining 95% over 135 min). The following reaction profile as a function of time was obtained;

TABLE 1

| | Time [min] | | | | | | | |
|---|---|---|---|---|---|---|---|---|
| | 6 | 35 | 60 | 85 | 115 | 145 | 170 | 205 |
| DEA added [g] | 2.0 | 2.0 | 7.7 | 15.6 | 24.7 | 32.9 | 40.3 | 40.3 |
| Butadiene added [g] | 1.5 | 1.5 | 5.9 | 11.7 | 18.2 | 24.4 | 29.8 | 29.8 |
| GC analyses [g] | | | | | | | | |
| Butadiene | <0.0001 | <0.0001 | <0.0001 | 0.033 | 0.029 | 0.045 | 0.066 | 0.028 |
| Butenes | 0.18 | 0.16 | 0.50 | 0.78 | 1.4 | 1.5 | 1.5 | 1.6 |
| BueDEA | <0.0001 | 0.24 | 2.4 | 20 | 32 | 47 | 71 | 66 |
| Concentrations | | | | | | | | |
| Butadiene [% by | <0.001% | <0.001% | <0.001% | 0.010% | 0.008% | 0.012% | 0.017% | 0.007% |
| weight] | | | | | | | | |
| DEA [% by weight] | 96% | 96% | 95% | 90% | 87% | 83% | 78% | 79% |

BueDEA = Butenyldiethylamine

The yield of NaNEt₂ was 7%, and the molar ratio of butenyldiethylamine to NaNEt₂ was about 15.

### Comparative Example 2

A dispersion of 0.5 mol of Na in 300 g of DEA and 10.315 g of n-undecane was initially placed in the reactor. A mixture of 0.55 mol of 1,3-butadiene and 0.55 mol of DEA was then metered in at 10° C. (about 5% over 15 min, 25 min delay, then remaining 95% over 150 min). The following reaction profile as a function of time was obtained.

TABLE 2

| | Time [min] | | | | | | |
|---|---|---|---|---|---|---|---|
| | 16 | 73 | 108 | 135 | 160 | 190 | 243 |
| DEA added [g] | 2.0 | 11.1 | 20.5 | 28.1 | 34.9 | 39.6 | 39.6 |
| Butadiene added [g] | 1.5 | 8.0 | 14.8 | 20.2 | 25.2 | 20.8 | 29.8 |
| GC analyses [g] | | | | | | | |
| Butadiene | 0.40 | <0.0001 | <0.0001 | <0.0001 | <0.0001 | <0.0001 | <0.0001 |
| Butenes | <0.0001 | 0.76 | 1.0 | 1.2 | 1.3 | 1.6 | 1.8 |
| BueDEA | <0.0001 | 11 | 22 | 38 | 46 | 61 | 64 |
| Concentrations | | | | | | | |
| Butadiene [% by | 0.13% | <0.001% | <0.001% | <.001% | <0.001% | <0.001% | <0.001% |
| weight] | | | | | | | |
| DEA [% by weight] | 97% | 93% | 90% | 86% | 84% | 80% | 80% |

BueDEA = Butenyldiethylamine

The yield of NaNEt₂ was 10%, and the molar ratio of butenyldiethylamine to NaNEt₂ was about 10.

### Comparative Example 3

A dispersion of 0.5 mol of Na in 110 g of TEA, 112.6 g of DEA and 11.40 g of n-undecane is initially placed in the reactor. A mixture of 0.55 mol of 1,3-butadiene and 1.65 mol of DEA is then metered in continuously at 30° C. (5% over 27 min, 30 min delay, then remaining 95% over 135 min). The following reaction profile as a function of time was obtained:

TABLE 3

| | Time [min] | | | | | | | |
|---|---|---|---|---|---|---|---|---|
| | 27 | 58 | 95 | 120 | 150 | 180 | 192 | 245 |
| DEA added [g] | 6.0 | 6.0 | 38.4 | 59.1 | 84.8 | 110.1 | 120.7 | 120.7 |
| Butadiene added [g] | 1.5 | 1.5 | 9.4 | 14.7 | 20.8 | 27.0 | 29.7 | 29.7 |
| GC analyses [g] | | | | | | | | |
| Butadiene | 1.2 | <0.0001 | <0.0001 | 0.026 | 0.021 | <0.0001 | <0.0001 | <0.0001 |
| Butenes | <0.0001 | 0.56 | 1.5 | 2.7 | 4.6 | 5.5 | 6.3 | 7.8 |
| BueDEA | <0.0001 | 2.3 | 9.4 | 21 | 31 | 53 | 63 | 54 |
| Concentrations | | | | | | | | |
| Butadiene [% by | 0.48% | <0.001% | <0.001% | 0.008% | 0.006% | <0.001% | <0.001% | <0.001% |
| weight] | | | | | | | | |
| DEA [% by weight] | 48% | 48% | 49% | 49% | 49% | 49% | 51% | 50% |

The yield of NaNEt₂ was 70%, and the molar ratio of butenyldiethylamine to NaNEt₂ was about 1.2.

### Comparative Example 4

A dispersion of 0.5 mol of Na in 308 g of TEA and 10.737 g of n-undecane was initially placed in the reactor. A mixture of 0.95 mol of 1,3-butadiene and 0.95 mol of DEA was then metered in at 30° C. (about 5% over 9 min, 36 min delay, then about 95% over 255 min). The following reaction profile; as a function of time was obtained:

TABLE 4

| | Time [min] | | | | | | | | | | |
|---|---|---|---|---|---|---|---|---|---|---|---|
| | 9 | 42 | 72 | 109 | 135 | 170 | 212 | 252 | 271 | 300 | 362 |
| DEA added [g] | 3.5 | 3.5 | 14.1 | 29.4 | 39.0 | 44.1 | 56.3 | 64.8 | 66.2 | 73.4 | 73.4 |
| Butadiene | 2.6 | 2.6 | 10.0 | 20.5 | 28.8 | 27.0 | 34.6 | 43.0 | 44.4 | 51.4 | 51.4 |
| added [g] | | | | | | | | | | | |
| GC analyses [g] | | | | | | | | | | | |
| Butadiene | 1.3 | 1.7 | 7.6 | 17 | 22 | 23 | 12 | 2.3 | 1.4 | 1.4 | 0.75 |
| Butenes | <0.0001 | <0.0001 | <0.0001 | 0.072 | 0.13 | 0.21 | 0.55 | 0.70 | 0.98 | 5.7 | 6.2 |
| DEA | 2.2 | 2.9 | 13 | 30 | 40 | 41 | 33 | 16 | 13 | 3.4 | 1.2 |
| BueDEA | <0.0001 | <0.0001 | <0.0001 | <0.0001 | <0.0001 | 0.15 | 42 | 85 | 95 | 90 | 95 |
| Concentrations | | | | | | | | | | | |
| Butadiene | 0.41% | 0.54% | 2.2% | 4.6% | 5.8% | 5.8% | 3.0% | 0.55% | 0.33% | 0.33% | 0.17% |
| [% by weight] | | | | | | | | | | | |
| DEA [% by | 0.68% | 0.89% | 3.9% | 8.1% | 11% | 11% | 8.1% | 3.8% | 3.1% | 0.82% | 0.30% |
| weight] | | | | | | | | | | | |

BueDEA = Butenyldiethylamine

The yield of NaNEt₂ was 50%, and the molar ratio of butenyldiethylamine to NaNEt₂ was about 2.7.

### Comparative Example 5

A dispersion of 0.5 mol of Na in 223.81 g of TEA and 11.215 g of n-undecane is initially placed in the reactor. A mixture of 0.55, mol of butadiene and 1.65 mol of DEA was then metered in continuously at 30° C. (5% over 7 min, 10 min delay, then remaining 95% over 133 nm). The following reaction profile as a function of time was obtained:

TABLE 5

| | Time [min] | | | | | | | | | |
|---|---|---|---|---|---|---|---|---|---|---|
| | 7 | 17 | 40 | 65 | 83 | 115 | 140 | 150 | 165 | 300 |
| DEA added [g] | 6.2 | 6.2 | 26.0 | 45.9 | 62.1 | 89.5 | 113.2 | 120.6 | 120.6 | 120.6 |
| Butadiene added [g] | 1.5 | 1.5 | 6.0 | 10.1 | 15.0 | 22.1 | 27.2 | 29.8 | 29.8 | 29.8 |
| GC analyses [g] | | | | | | | | | | |
| Butadiene | 2.0 | 0.4 | 4.6 | 7.0 | 7.7 | 15 | 17 | 22 | 21 | <0.0001 |
| Butenes | 0.077 | 0.38 | 2.4 | 3.6 | 6.5 | 6.6 | 7.2 | 7.0 | 6.9 | 13 |
| DEA | 1.0 | 3.2 | 8.3 | 10 | 24 | 22 | 56 | 49 | 86 | 76 |
| BueDEA | <0.0001 | <0.0001 | 0.11 | 0.19 | 0.55 | 0.75 | 5.7 | 4.1 | 4.3 | 44 |
| Concentrations | | | | | | | | | | |
| Butadiene [% by | 0.82% | 0.17% | 1.8% | 2.5% | 2.6% | 4.5% | 4.8% | 6.0% | 5.8% | <0.001% |
| weight] | | | | | | | | | | |
| DEA [% by weight] | 0.44% | 1.4% | 3.4% | 4.2% | 9.0% | 8.3% | 18% | 16% | 25% | 21% |

BueDEA = Butenyldiethylamine

The yield of NaNEt₂ was 95%; full conversion of Na was obtained. The molar ratio of butenyldiethylamine to NaNEt₂ was about 0.7. The butadiene which has accumulated after 170 minutes reacts quickly and forms large amounts of butenyldiethylamine.

### Example 1

A dispersion of 0.55 mol of Na in 220 g of n-heptane land 7.001 g of n-undecane was initially placed in the reactor. A mixture of 6.35 mol of 1,3-butadiene and 1.05 mol of DEA was then metered in continuously at 30° C. (5% over 11 min, 30 min delay, then remaining 95% over 140 min). After 180 minutes, the butene content no longer increased. The reaction is complete at this point. If the reaction is not stopped, an undesirably large amount of butenyldiethylamine is formed, as analysis of the reaction mixture after 230 minutes indicates. The following reaction profile as a function of time was obtained:

TABLE 6

| | Time [min] | | | | | | | |
|---|---|---|---|---|---|---|---|---|
| | 11 | 41 | 60 | 90 | 120 | 150 | 180 | 230 |
| DEA added [g] | 3.8 | 3.8 | 11.2 | 27.4 | 43.7 | 60.3 | 76.4 | 76.8 |
| Butadiene added [g] | 0.9 | 0.9 | 2.9 | 6.8 | 10.8 | 14.9 | 18.8 | 18.9 |
| GC analyses [g] | | | | | | | | |
| Butadiene | 0.55 | 0.023 | <0.0001 | <0.0001 | <0.0001 | 0.077 | 0.35 | 0.053 |
| Butenes | 0.041 | 0.92 | 2.3 | 5.2 | 7.7 | 11 | 13 | 12 |
| DEA | 2.1 | 1.0 | 3.2 | 7.7 | 12 | 18 | 28 | 34 |
| BueDEA | <0.0001 | <0.0001 | <0.0001 | <0.0001 | <0.0001 | 0.13 | 4.7 | 13 |
| Concentrations | | | | | | | | |
| Butadiene [% by | 0.24% | 0.010% | <0.001% | <0.001% | <0.001% | 0.027% | 0.12% | 0.018% |
| weight] | | | | | | | | |
| DEA [% by weight] | 0.91% | 0.44% | 1.37% | 3.2% | 4.8% | 6.9% | 10% | 12% |

BueDEA = Butenyldiethylamine

The yield of NaNEt₂ was 85%; full conversion of Na was achieved. The molar ratio of butenyldiethylamine to NaNEt₂ was about 0.2 (measured after 180 minutes).

### Example 2

A dispersion of 0.5 mol of Na in 198 g of TEA, 22 g of DEA and 11.126 g of n-undecane was initially placed in the reactor. A mixture of 0.30 mol of 1,3-butadiene and 0.60 mol of DEA was then metered in continuously at 30° C. (5% over 9 min, 30 min delay, then remaining 95% over 140 min). The following reaction profile as a function of time was obtained:

TABLE 7

| | Time [min] | | | | | | |
|---|---|---|---|---|---|---|---|
| | 9 | 40 | 75 | 105 | 135 | 165 | 180 |
| DEA added [g] | 2.3 | 2.3 | 11.9 | 21.4 | 30.6 | 39.9 | 44.0 |
| Butadiene added [g] | 0.8 | 0.8 | 4.4 | 7.9 | 11.2 | 14.6 | 16.2 |
| GC analyses [g] | | | | | | | |
| Butadiene | 0.33 | <0.0001 | <0.0001 | 0.077 | 0.056 | 0.17 | 0.20 |
| Butenes | 0.72 | 1.1 | 1.9 | 4.9 | 8.9 | 11 | 11 |
| DEA | 21 | 21 | 21 | 21 | 22 | 24 | 25 |
| BueDEA | 0.039 | 0.044 | 0.12 | 0.90 | 0.75 | 2.6 | 5.8 |
| Concentrations | | | | | | | |
| Butadiene [% by | 0.14% | <0.001% | <0.001% | 0.031% | 0.022% | 0.063% | 0.075% |
| weight] | | | | | | | |
| DEA [% by weight] | 10% | 10% | 10% | 10% | 10% | 10% | 11% |

BueDEA = Butenyldiethylamine

The yield of NaNEt₂ was 77%; for conversion of Na was achieved. The molar ratio of butenyldiethylamine to NaNEt₂ was about 0.25.

### Example 3

A dispersion of 1 mol of Na in 270 g of TEA, 30 g of DEA and 11.134 g of n-undecane is initially placed in the reactor. A mixture of 0.6 mol of butadiene and 1.2 mol of DEA is then metered in continuously at 50° C. (5% over 32 min, 30 nin delay, then remaining 95% over 221 min). The following reaction profile as a function of time was obtained:

TABLE 8

| | Time [min] | | | | | | | | |
|---|---|---|---|---|---|---|---|---|---|
| | 32 | 62 | 100 | 130 | 160 | 220 | 250 | 283 | 403 |
| DEA added [g] | 4.4 | 4.4 | 17.3 | 28.0 | 38.8 | 63.5 | 74.4 | 87.8 | 87.8 |
| Butadiene added [g] | 1.6 | 1.6 | 6.1 | 10.2 | 14.3 | 23.4 | 27.6 | 32.5 | 32.5 |
| GC analyses [g] | | | | | | | | | |
| Butadiene | 0.26 | <0.0001 | 1.8 | 1.9 | 0.26 | 0.25 | 0.054 | 0.066 | <0.0001 |
| Butenes | 0.46 | 1.2 | 2.0 | 3.7 | 8.5 | 16 | 20 | 23 | 26 |
| DEA | 36 | 37 | 45 | 46 | 46 | 48 | 47 | 47 | 50 |
| BueDEA | 0.23 | 0.65 | 1.5 | 4.7 | 6.9 | 10 | 8.7 | 11 | 17 |
| Concentrations | | | | | | | | | |
| Butadiene [% by | 0.082% | <0.001% | 0.54% | 0.55% | 0.075% | 0.068% | 0.014% | 0.016% | <0.001% |
| weight] | | | | | | | | | |
| DEA [% by weight] | 11% | 12% | 14% | 14% | 13% | 13% | 13% | 13% | 13% |

BueDEA = Butenyldiethylamine

The yield of NaNEt₂ was 88%; full conversion of Na was achieved. The molar ratio of butenyldiethylamine to NaNEt₂ was about 0.15.

TABLE 9
Summary of the experiments

| | CE1 | CE2 | CE3 | CE4 | CE5 | E1 | E2 | E3 |
|---|---|---|---|---|---|---|---|---|
| Na [mol] | 0.5 | 0.5 | 0.5 | 0.5 | 0.5 | 0.55 | 0.5 | 1 |
| dispersed in | DEA | DEA | DEA/TEA | TEA | TEA | Heptane | DEA/TEA | DEA/TEA |
| Reaction | | | | | | | | |
| Temp. [° C.] | 30 | 10 | 30 | 30 | 30 | 30 | 30 | 50 |
| Butadiene added | 0.55 | 0.55 | 0.55 | 0.95 | 0.55 | 0.35 | 0.3 | 0.6 |
| [mol] | | | | | | | | |
| DEA added [mol] | 0.55 | 0.55 | 1.65 | 0.95 | 1.65 | 1.05 | 0.6 | 1.2 |
| DEA conc. [% by | 96-78% | 97-80% | 48-51% | 0.3-11% | 0-25% | 0.44-12% | 10-11% | 11-14% |
| weight] | | | | | | | | |
| during the reaction | | | | | | | | |
| 1.3-Butadiene conc. | ≦0.017 | ≦0.13 | ≦0.48 | ≦5.8 | ≦6.0 | ≦0.24 | ≦0.14 | ≦0.55 |
| [% by weight] | | | | | | | | |
| during the reaction | | | | | | | | |
| Result | | | | | | | | |
| Yield (Na) | 7% | 10% | 70% | 50% | 95% | 85% | 77% | 88% |
| Complete | no | no | no | no | yes | yes | yes | yes |
| conversion (Na) | | | | | | | | |
| BDEA/NaNEt₂ | 15 | 10 | 1.2 | 2.7 | 0.7 | 0.2 | 0.25 | 0.15 |
| [mol/mol] | | | | | | | | |

1-11. (canceled)

12. A process for preparing dialkylamides of the alkali metals by reacting the corresponding dialkylamine with the corresponding alkali metal in the presence of an electron-donating substance selected from the group consisting of 1,3-butadiene, isoprene, naphthalene and/or styrene, which comprises suspending the corresponding alkali metal in a solvent and subsequently adding dialkylamine and electron-donating substance in such a way that the dialkylamine is present in an amount of up to 45% by weight, and the electron-donating substance is present in an amount of up to 5% by weight.

13. A process as claimed in claim 12, wherein the dialkylamine is present in an amount of up to 25% by weight.

14. A process as claimed in claim 12, wherein the dialkylamine is present in an amount of up to 15% by weight.

15. A process as claimed in claim 12, wherein the electron-donating substance is present in an amount of up to 3% by weight.

16. A process as claimed in claim 12, wherein the electron-donating substance is present in an amount of up to 1.5% by weight.

17. A process as claimed in claim 12, wherein the electron-donating substance used is 1,3-butadiene.

18. A process as claimed in claim 12, wherein the alkali metal is selected from among sodium, potassium and lithium preferably, and is particularly preferably sodium.

19. A process as claimed in claim 18, wherein the alkali metal is selected from among sodium and potassium.

20. A process as claimed in claim 18, wherein the alkali metal is sodium.

21. A process as claimed in claim 12, wherein the molar ratio of 1,3-butadiene to the alkali metal used is from 0.5 to 1.2.

22. A process as claimed in claim 21, wherein the molar ratio of 1,3-butadiene to the alkali metal used is from 0.5 to 1.0.

23. A process as claimed in claim 21, wherein the molar ratio of 1,3-butadiene to the alkali metal used is from 0.5 to 0.7.

24. A process as claimed in claim 12, wherein sodium is used as alkali metal and has a size distribution such that 50% by weight of the particles have a size of <100 μm.

25. A process as claimed in claim 12, wherein the sodium has a size distribution such that 50% by weight of the particles have a size of <300 μm.

26. A process as claimed in claim 12, wherein the sodium has a size distribution such that 50% by weight of the particles have a size of <100 μm.

27. A process as claimed in claim 12, wherein the alkali metal is suspended in a saturated hydrocarbon prior to the reaction.

28. A process as claimed in claim 27, wherein the alkali metal is suspended in low-boiling paraffins or mixtures thereof, high-boiling paraffins optionally comprising branched or unbranched saturated cycloparaffins, or monoolefins and/or a trialkylamine.

29. A process as claimed in claim 12, wherein the alkyl groups on the alkylamine have from 1 to 50 carbon atoms and may be linear or branched, acyclic or cyclic and may bear one or more inert substituents.

30. A process as claimed in claim 29, wherein the alkyl groups on the alkylamine are selected from among methyl, ethyl, n-propyl, i-propyl, n-butyl, sec-butyl, i-butyl, tert-butyl, n-pentyl, i-pentyl, decyl, dodecyl, hexydecyl, cyclohexyl, cyclopentyl.

31. A process as claimed in claim 29, wherein the alkyl groups are selected among these alkyl radicals being given to those which result in alkylamines having a hydrogen atom in the β-position relative to the nitrogen atom.

32. A process as claimed in claim 29, wherein the alkyl groups are selected from among ethyl and n-butyl.

33. A process as claimed in claim 29, wherein the starting amine is diethylamine.

34. A process as claimed in claim 12, wherein the preparation of the amide catalyst from elemental metal is carried out at from −30 to 90° C.

35. A process as claimed in claim 34, wherein the preparation of the amide catalyst is carried out at from 0 to 70° C.

36. A process as claimed in claim 34, wherein the preparation of the amide catalyst is carried out at from 30 to 50° C.

37. A process as claimed in claim 34, wherein the metal is sodium.

38. A mixture comprising alkali metal dialkylamide, any solvent used and secondary amine/amines from a process as claimed in claim 12, wherein the molar ratio of all hydroamination products obtained to the alkali metal dialkylamide is <1.5.

39. A mixture as claimed in claim 38, wherein the molar ratio of all hydroamination products obtained to the alkali metal dialkylamide is <1.

40. A mixture as claimed in claim 38, wherein the molar ratio of all hydroamination products obtained to the alkali metal dialkylamide is <0.3.

41. A process for preparing trialkylamines from the corresponding dialkylamine and olefin, wherein a dialkylamide is used as a catalyst which has been prepared by reacting the corresponding dialkylamine with the corresponding alkali metal in the presence of an electron-donating substance selected from the group consisting of 1,3-butadiene, isoprene, naphthalene and styrene, which comprises suspending the corresponding alkali metal in a solvent and subsequently adding dialkylamine and electron-donating substance in such a way that the dialkylamine is present in an amount of up to 45% by weight, and the electron-donating substance is present in an amount of up to 5% by weight.

42. A process as claimed in claim 41, wherein the dialkylamine is present in a amount of up to 25% by weight.

43. A process as claimed in claim 41, wherein the dialkylamine is present in an amount of up to 15% by weight.

44. A process as claimed in claim 41, wherein the electron-donating substance is present in an amount of up to 3% by weight.

45. A process as claimed in claim 41, wherein the electron-donating substance is present in an amount of up to 1.5% by weight.

46. A process as claimed in claim 41, wherein the olefin with which the starting amine is reacted is an olefin having 2 to 20 carbon atoms.

47. A process as claimed in claim 41, wherein the olefin is ethylene, propylene, 1-butene, 2-butene or cyclohexene.

48. A process as claimed in claim 41, wherein the olefin is ethylene.
